(19) United States
(12) Patent Application Publication
(10) Pub. No.: US 2026/0270120 A1
(43) Pub. Date: Sep. 10, 2026

(54) COORDINATED BEAMFORMING WITH SEPARATED SINGULAR VALUE DECOMPOSITION

(71) Applicant: Samsung Electronics Co., Ltd., Gyeonggi-do (KR)

(72) Inventors: Aiguo YAN, San Jose, CA (US); Eunsung JEON, Gyeonggi-do (KR); Jung Hyun BAE, San Diego, CA (US); Dongwoon BAI, San Diego, CA (US)

(21) Appl. No.: 19/537,152

(22) Filed: Feb. 11, 2026

Related U.S. Application Data
(60) Provisional application No. 63/767,970, filed on Mar. 6, 2025.
(60) Provisional application No. 63/770,844, filed on Mar. 12, 2025.
(60) Provisional application No. 63/846,328, filed on Jul. 18, 2025.
(60) Provisional application No. 63/875,166, filed on Sep. 3, 2025.
(60) Provisional application No. 63/874,893, filed on Sep. 3, 2025.
(60) Provisional application No. 63/880,292, filed on Sep. 11, 2025.

(51) Int. Cl. H04L 25/02; H04B 7/06

(52) U.S. Cl. CPC H04L 25/0242; H04B 7/0617; H04L 25/0224

(57) ABSTRACT

A method, system and station are disclosed for coordinated beamforming with separated singular value decomposition (SVD). The method comprises performing, with a first access point (AP1), an intra-basic service set (BSS) sounding of a first station (STA1) to obtain an STA1-AP1 intra-BSS left singular matrix U₁₁ and performing, with a second access point (AP2), a cross-BSS sounding of the STA1 to obtain a STA1-AP2 cross-BSS channel matrix H₁₂. The method also comprises determining, with the STA1, a new STA1-AP2 cross-BSS channel matrix

$${H}_{12}^{New}$$

based on a submatrix of the STA1-AP1 intra-BSS left singular matrix U₁₁ and the STA1-AP2 cross-BSS channel matrix H₁₂.

### CROSS-REFERENCE TO RELATED APPLICATION

This application claims the priority benefit under 35 U.S.C. § 119(e) of U.S. Provisional Application No. 63/767,970, filed on Mar. 6, 2025, U.S. Provisional Application No. 63/770,844, filed on Mar. 12, 2025, U.S. Provisional Application No. 63/880,292, filed on Sep. 11, 2025, U.S. Provisional Application No. 63/875,166, filed Sep. 3, 2025, U.S. Provisional Application No. 63/874,893, filed on Sep. 3, 2025, and U.S. Provisional Application No. 63/846,328, filed on Jul. 18, 2025, the disclosure of each of which is incorporated by reference in its entirety as if fully set forth herein.

### TECHNICAL FIELD

The disclosure generally relates to performing decomposition for coordinated beamforming (Co-BFing). More particularly, the subject matter disclosed herein relates to improvements to Co-BFing with separated singular value decomposition (SVD).

### SUMMARY

In wireless networks, an access point (AP) can serve as a hub for a plurality of wireless network devices referred to as stations (STAs). The STAs are typically within a service area of an associated AP. The STAs may be fixed, mobile, semi-fixed, etc. The STAs may be communicatively coupled with at least the associated AP. That is, a given STA may be associated with only one AP but can communicate with non-associated APs. In addition, the STAs associated with a given AP typically do not communicate directly with each other within the wireless network. However, the STAs may have additional localized wireless features, such as Bluetooth, non-AP associated wireless fidelity (Wi-Fi) networks, ad hoc mesh networks, etc. A given STA can be in a service area of two or more APs. For example, an STA may be in a first service area associated with a first AP (AP1), a second service area associated with a second AP (AP2), and/or etc.

FIG. 1 is a schematic of a system 100 including an overlapping basic service set (OBSS) between AP1 and AP2 according to an embodiment.

Referring to FIG. 1, six STAs are shown, where four of the STAs are located in service areas associated with both AP1 and AP2. Associations between the six STAs and their respective APs are illustrated as comm-links depicted by lightning bolts. As shown in FIG. 1, the STA1, STA2, and STA5 may be associated with AP1. In addition, STA3, STA4, and STA6 are shown as associated with AP2. The STA1, STA2, STA3, and STA4 are in an overlapping service area.

It should be appreciated that standards may use differing terms for similar functions. Accordingly, “access point” or “AP” may be used interchangeably with other terms, such as a “base station,” “station functioning as an access point,” etc. As described herein, a wireless network of an AP and its associated STAs can be referred to as a basic service set (BSS). The term OBSS can refer to basic service sets that partially overlap. From a geographic perspective, the OBSS can be viewed as overlapping service areas.

An AP can be any configuration of hardware and software comprising a backhaul equipment for connecting to a wired network, a baseband processor for signal processing of a baseband signal, a modulating unit to modulate and demodulate between the baseband signal and a wireless signal (e.g., received or to be transmitted), and an antenna array that transmits and receives the transmission signal. The antenna array may include a plurality of antennas collectively capable of shaping the antenna's radiation patterns into directional communication beams using, for example, constructive interference between signals emitted by radiating elements of the arrays.

Various transmission modes may be employed for intra-BSS and OBSS STAs, including coordinated beamforming (Co-BF) multi-user (MU)-multiple input, multiple output (MIMO), and/or single user (SU)-MIMO. MU-MIMO may be the use of a beam forming by a single AP to transmit to a particular STA. Co-BF is the use of beamforming by two APs to transmit to a single STA. Beamforming may use antenna arrays comprised of antennas to shape the constructive and destructive interference of the radiation patterns.

To address this issue, the beamforming can use precoding matrices P that are applied to each antenna's output. Transmission from an AP to a STA may be decoded by using a receiver processing matrix Q. The precoding matrices P and the receiver processing matrices Q can be determined based on channel matrices H between the AP antennas and STA antennas. With more particularity, various sounding methods can determine a channel matrix H and various decomposition and matrix manipulation methods can determine the precoding matrices P and the receiver processing matrices Q based on the channel matrices H.

One issue with the above approach is that some sounding, decomposition, and/or matrix manipulation methods may only support full nulling at a STA. That is, the receiver processing matrices Q may not be configured to achieve zero multi-user interference (zero-MUI) when the precoding matrix P causes an AP to transmit to a non-associated STA. By way of illustration, sequential sounding using standard singular value decomposition (SVD) may only support full nulling whereas joint sounding with joint SVD may support partial nulling.

Another issue is that some sounding, decomposition, and/or matrix manipulation methods may not support sounding result reuse. Reusing sounding results can significantly reduce the number of frame exchanges required for Co-BF transmission, which may be a significant computation burden.

To overcome these issues, systems and methods are described herein for Co-BFing with separated SVD.

The above approaches improve on previous methods because sequential sounding and joint sounding can both use separated SVD feedback. In addition, the separated SVD feedback can be reused in SU/MU-MIMO beamforming.

In an embodiment, a method comprises performing, with a first access point (AP1), an intra-BSS sounding of a first station (STA1) to obtain an STA1-AP1 intra-BSS left singular matrix U₁₁ and performing, with a second access point (AP2), a cross-BSS sounding of the STA1 to obtain a STA1-AP2 cross-BSS channel matrix H₁₂. The method ma also comprise determining, with the STA1, a new STA1-AP2 cross-BSS channel matrix

$${H}_{12}^{New}$$

based on a submatrix of the STA1-AP1 intra-BSS left singular matrix U₁₁ and the STA1-AP2 cross-BSS channel matrix H₁₂.s

In an embodiment, a system comprises an AP1 configured to perform an intra-BSS sounding of a STA1 to obtain an STA1-AP1 intra-BSS left singular matrix U₁₁ and a AP2 configured to perform a cross-BSS sounding of the STA1 to obtain a STA1-AP2 cross-BSS channel matrix H₁₂. The STA1 may be configured to determine a new STA1-AP2 cross-BSS channel matrix

$${H}_{12}^{New}$$

based on a submatrix of the STA1-AP1 intra-BSS left singular matrix U₁₁ and the STA1-AP2 cross-BSS channel matrix H₁₂.

In an embodiment, a STA1 comprises a radio configured to receive an intra-BSS sounding from the AP1 and receive a cross-BSS sounding from an AP2 and a processing circuit. The processing circuit may be configured to determine an STA1-AP1 intra-BSS left singular matrix U₁₁ based on the sounding from the AP1, determine a STA1-AP2 cross-BSS channel matrix H₁₂ based on the sounding from the AP2, and determine a new STA1-AP2 cross-BSS channel matrix

$${H}_{12}^{New}$$

based on a submatrix of the STA1-AP1 intra-BSS left singular matrix U₁₁ and the STA1-AP2 cross-BSS channel matrix H₁₂.

### BRIEF DESCRIPTION OF THE DRAWING

In the following section, the aspects of the subject matter disclosed herein will be described with reference to exemplary embodiments illustrated in the figures, in which:

FIG. 1 is a schematic of a system 100 including an OBSS between AP1 and AP2 according to an embodiment.

FIG. 2 depicts an example system 200 for Co-BFing with separated SVD.

FIG. 3 is a sequence diagram 300 for sequential sounding using SVD.

FIG. 4 is a sequence diagram 400 for joint SVD with joint sounding in Co-BFing.

FIG. 5 is a sequence diagram 500 for separated SVD with sequential sounding.

FIG. 6 is a sequence diagram 600 for separated SVD with joint sounding.

FIG. 7 is a method 700 for Co-BFing using separated SVD.

FIG. 8 is a block diagram of an electronic device in a network environment 800, according to an embodiment.

FIG. 9 shows a system 900 including an AP1 910, an AP2 920, and a STA 930.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

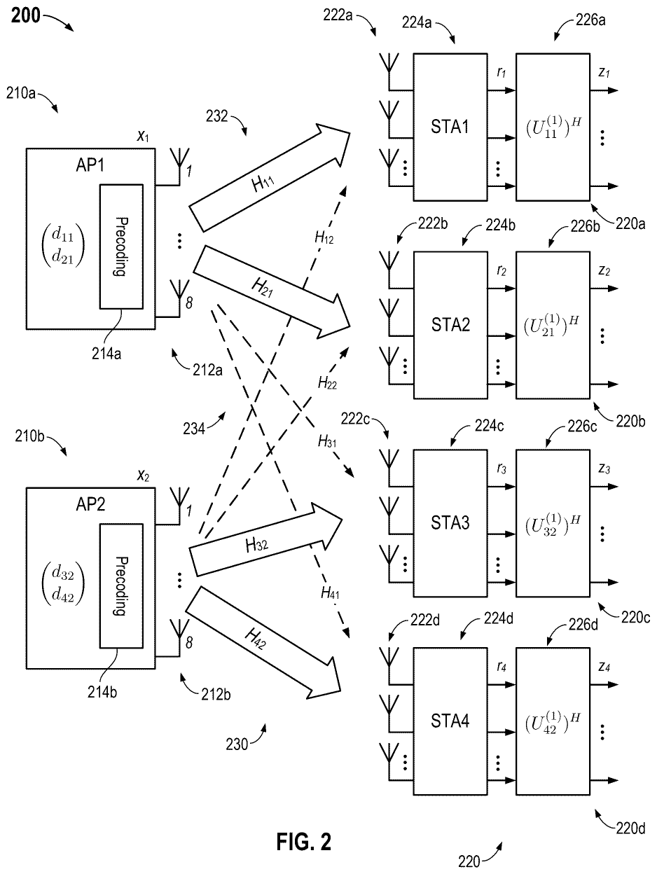

FIG. 2 depicts an example system 200 for Co-BFing with separated SVD.

Referring to FIG. 2, the system 200 includes APs 210 and STAs 220. The APs 210 are comprised of a AP1 210a and a AP2 210b. The STAs 220 may include a STA1 220a, a STA2 220b, a STA3 220c, and a STA4 220d. The APs 210 may be coupled, desirably or not, with the STAs 220 via channels 230. The AP1 and AP2 210a, 210b may respectively include a AP1 antenna array 212a and a AP2 antenna array 212b and a AP1 and AP2 precoding modules 214a, 214b. The STA1 through STA4 220a-220b may respectively include a STA1 through STA4 antenna arrays 222a-222d, a STA1 through STA4 receivers 224a-224d, and a STAs through STA4 processing modules 226a-226d. The channels 230 may be comprised of intra-BSS channels 232 and cross-BSS channels 234. The channels 230 are represented by arrows, where solid arrows can represent intra-BSS channels 232 and the dashed arrows may represent cross-BSS channels 234.

### Associated Stations and Data

The AP1 210a may be associated with the STA1 and STA2 220a, 220b. The AP2 210b may be associated with the STA3 and STA4 220c, 220d. The AP1 and AP2 210a, 210b may accordingly include data that are intended for a downlink transmission to their respectively associated STAs. For example, the AP1 210a may include an AP1 data vector

$$( \begin{matrix}{d}_{11} \\ {d}_{21}\end{matrix} )$$

and the AP2 210b may include an AP2 data vector

$$( \begin{matrix}{d}_{32} \\ {d}_{42}\end{matrix} ) .$$

The AP1 and AP2 data vector elements d₁₁, d₂₁, d₃₂, and d₄₂ may be data streams.

The subscripts indicate the STA-AP channel a given data stream is to be transmitted over. For example, the data stream d₂₁ may be transmitted from AP1 to STA2. Accordingly, during SU-MIMO and MU-MIMO, the data stream d₂₁ may be transmitted from AP1 to STA2. However, during Co-BF one or more additional APs may be employed. For example, the STA2 220b may receive the data stream d₂₁ from the AP1 210a and the AP2 210b, simultaneously. The data streams d₁₁, d₂₁, d₃₂, and d₄₂ may be transmitted via the AP1 and AP2 antenna arrays 212a, 212b to the subscript indicated STAs.

### AP Antenna Arrays

The AP1 and AP2 antenna arrays 212a, 212b are each shown as including a first through eighth antenna. The antennas of the AP1 and AP2 antenna arrays 212a, 212b can be configured to transmit and/or receive signals. The phase and magnitude of carrier signals from each of the antenna in one of the AP1 or AP2 antenna array 212a, 212b may be manipulated to form a “beam.” The beam can be a spatial region of constructive interference of the carrier signals emitted by the antennas of the AP1 or AP2 antenna array 212a, 212b. Nulls occur in spatial regions of destructive interference of the carrier signals from the antennas in the AP1 or AP2 antenna array 212a, 212b destructively interfere. The beam may be directed in spatial path(s) that can maximize a signal strength at one of the associated STAs.

### Precoding Modules

The AP1 and AP2 precoding modules 214a, 214b can be used to calculate the desired phase and magnitude of the signals emitted by the antennas of the AP1 or AP2 antenna array 212a, 212b. For example, by way of illustration, the AP1 210a can use a precoding matrix P in the AP1 precoding modules 214a to adjust the magnitude and/or phase of a signal carrying data on a per antenna basis prior to transmission. The phase and magnitude of the signals emitted by the antennas of the AP1 or AP2 antenna array 212a, 212b may be adjusted to form the beams. The precoding matrices P in the AP1 and AP2 precoding modules 214a, 214b can be determined using various decomposition methods, described in more detail in the following, based on the channels 230.

### Channel Matrices

Referring to FIG. 2, the intra-BSS channels 232 include channel matrix labels indicating a channel between one of the STAs 220 and one of the APs 210. As shown in FIG. 2, the intra-BSS channels 232 are labeled with an STA1-AP1 channel matrix H₁₁, STA2-AP1 channel matrix H₂₁, a STA3-AP2 channel matrix H₃₂, and a STA4-AP2 channel matrix H₄₂. Accordingly, a channel matrix Hᵢⱼ notation may include subscripts where subscript “i” indicates a STA and subscript “j” indicates an AP. The channel matrix Hᵢⱼ can include complex channel coefficients hₘₙ. The complex channel coefficients hₘₙ can represent a signal propagation between an nth antenna of the AP1 or AP2 antenna array 212a, 212b and an mth antenna of the STA1 through STA4 antenna arrays 222a-222d.

For example, referring to FIG. 2, where the AP1 and AP2 antenna arrays 212a, 212b each including eight antennas and the STA1 through STA4 antenna arrays 222a-222d, each including three antennas, the STA1-AP1 channel matrix H₁₁ may be a 3×8 matrix as follows:

$${H}_{12} = [ \begin{matrix}{h}_{11} & {h}_{12} & {h}_{13} & {h}_{14} & {h}_{15} & {h}_{16} & {h}_{17} & {h}_{18} \\ {h}_{21} & {h}_{22} & {h}_{23} & {h}_{24} & {h}_{25} & {h}_{26} & {h}_{27} & {h}_{28} \\ {h}_{31} & {h}_{32} & {h}_{33} & {h}_{34} & {h}_{35} & {h}_{36} & {h}_{37} & {h}_{38}\end{matrix} ] . \qquad Equation [ 1 ]$$

By way of illustration a training signal transmitted by a 7^{th} antenna of the AP2 antenna array 212b and received by a 3^{rd} antenna of the STA1 antenna array 222a may be represented by the complex channel coefficient h₃₇. Although a 3×8 matrix is described, any suitable configuration of the APs 210 and STAs 220 can be employed. Accordingly, any suitable channel matrix with more or fewer antennas on the APs 210 and/or STAs 220 can be employed. For example, the STA1 through STA4 antenna arrays 222a-222d may include 4 antennas and accordingly, the STA1-AP1 channel matrix H₁₁ may be a 4×8 matrix.

### STA Receivers

The STA1 through STA4 receivers 224a-224d can receive the signals transmitted by the AP1 and AP2 210a, 210b. The STA1 through STA4 receivers 224a-224d can perform various front-end related functions, such as frequency down conversion, analog-to-digital conversion (ADC), orthogonal frequency division multiplexing (OFDM) demodulation, etc. to obtain a STA1 through STA4 received signal r₁-r₄ although any suitable arrangement can be employed.

During a data transmission, the signals received by the STA1 and STA2 220a, 220b can include the data streams d₁₁, d₂₁, d₃₂, and d₄₂ described in the foregoing. The data streams d₁₁, d₂₁, d₃₂, and d₄₂ may be encoded into the signals using OFDM although any suitable encoding may be employed. When SU-MIMO and MU-MIMO, a transmission from the AP2 210b intended for the second STA2 220b but received also by the STA1 220a may be considered MUI. During Co-BF, both AP1 210a and the AP2 210b may transmit to the STA1 220a to provide, for example, data stream d₁₁.

### Processing Matrices

The STAs 220 can include the STA1 through STA4 processing modules 222a-222d to separate the data streams d₁₁, d₂₁, d₃₂, and d₄₂ received by the corresponding STA1 through STA4 antenna arrays 222a-222d. Referring again to the STA1 220a for the sake of discussion, the STA1 processing module 226a can separate the data stream d₁₁ from the other data streams d₂₁, d₃₂, and d₄₂ and noise of the signals received by the STA1 antenna array 222a. For example, referring again to FIG. 2, the STA1 receiver 224a can demodulate the signals received at the STA1 antenna array 222a into a received signal r₁ that may include the received data streams d₁₁, d₂₁, d₃₂, and d₄₂ and noise.

The received signals r₁ can be provided to the first processing module 226a. The received signals r₁ can include signals from the STA1-AP1 intra-BSS channel H₁₁ and the STA1-AP2 interference channel H₁₂. The STA1 processing module 226a can process the received signals r₁ to separate out the data stream d₁₁. The STA1 processing module 226a can be obtained through matrix decomposition of the channel matrix H, which will be discussed in more detail in the following. The AP1 processing module 226a can provide a recovered data stream z₁, which may ideally be the same as the data stream d₁₁.

### MUI

As discussed above, MUI can occur when a STA is receiving a signal from an associated AP and non-associated AP. The signals received by each of the STA1 through STA4 receivers 224a-224d may be comprised of desired signals and undesirable signals. For example, the STA1 220a may receive signals from the AP2 210b during SU-MIMO and MU-MIMO transmissions by the second AP 210b and thus may experience MUI. Additionally, or alternatively, the AP1 210a may perform a MU-MIMO transmission to the STA1 and STA2 220a, 220b where the STA1 220a experiences interference from the beam directed to the STA2 220b. In contrast to the undesirably interfering signals, Co-BF may be employed with the AP1 and AP2 210a, 210b to transmit data to the fSTA1 220a and thus signals from the AP2 210b at the STA1 220a may be desirable.

### Channel Notation

A channel matrix Hᵢⱼ notation can indicate whether the channels are intra-BSS or cross-BSS channels if the associations between the AP1 and AP2 210a, 210b and the STA1 through STA4 220a-220d are known. For example, referring to FIG. 2, the intra-BSS channels 232 include the STA1-AP1 channel H₁₁, the STA2-AP1 channel H₂₁, the STA3-AP2 channel H₃₂, and the STA4-AP2 channel H₄₂. The cross-BSS channels 234 include the STA1-AP2 channel H₁₂, the STA2-AP2 channel H₂₂, the STA3-AP1 channel H₃₁, and the STA4-AP1 channel H₄₁. A combination of the intra-BSS channels 232 and the cross-BSS channels 234 received at each of the STA1 through STA4 220a-220d can be denoted using concatenation as follows: H₁=[H₁₁ H₁₂], H₂=[H₂₁ H₂₂], H₃ '₂ [H₃₁ H₃₂], and H₄=[H₄₁ H₄₂].

### Nulling

In the context of MUI, full nulling may refer to when a given STA's antennas receive no signals desirably transmitted to other STAs. For example, referring to FIG. 2, the STA1 through STA4 received signals rᵢ-r₄ provided the STA1 through STA4 receivers 224a-224d may not include MUI. The full nulling where the received signals rᵢ do not include MUI may be accomplished by using suitable right singular matrices V. Partial nulling may refer to when the STA antennas receive signals from non-associated APs but the MUI can be eliminated by STA processing matrices to achieve zero-MUI at the recovered data stream zᵢ. For example, referring again to FIG. 2, the STA1 220a recovered data stream z₁ may not include MUI even though the received signals r₁ may include MUI.

### Sounding and Intra-BSSS and Cross-BSS

An intra-BSS and cross-BSS report may involve the use of sounding or transmission of training signals from one or more APs to a STA. The STA can use the training signals to determine a channel matrix Hᵢⱼ. An intra-BSS sounding may include transmitting training signals from an AP to an associated STA. A cross-BSS sounding may include transmitting training signals from an AP to a non-associated STA. Sequential sounding may include an intra-BSS sounding and a cross-BSS sounding that occurs at different times. Joint sounding may include an intra-BSS sounding and a cross-BSS sounding that occurs at the same time. The training signals may be part of a NDP transmitted by the AP.

The complex channel coefficients hᵢⱼ can determined by a STA based on the received training signals. For example, the above exemplary STA1-AP2 channel matrix H₁₂ can be obtained by transmitting training signals from the eight antennas in the AP2 antenna array 212b to the three antennas of the STA1 antenna array 222a. The STA1 220a can measure the signal received by the STA1 antenna array 222a and determine the STA1-AP2 channel matrix H₁₂. As will be explained in more detail in the following, the STA1 220a can determine the AP1 precoding module 214a and the STA1 processing module 226a from the STA1-AP2 channel matrix H₁₂.

### Decompositions

Singular value decompositions (SVD) can be used to decouple a channel into multiple independent data streams. SVD may include an independent SVD, a joint SVD, and a separated SVD. All three may use intra-BSS and cross-BSS CSI reports. For example, where an intra-BSS CSI report is available for a sounding from AP1 to STA1 associated with the AP1, an STA1-AP1 intra-BSS channel matrix H₁₁ can be determined. Similarly, where a cross-BSS CSI report is available between, for example, the STA1 and the AP2 which may not be associated with STA1, an STA1-AP2 cross-BSS channel matrix H₁₂ can be determined.

When using SVD, the channel matrix H can be decomposed into right singular matrices V and receiver processing matrices Q=U^{H}, where the superscript H denotes a Hermitian transpose. The left singular matrix U may be an N×M matrix, where M is not necessarily equal to N. The receiver processing matrix Q may be based on a strict usable submatrix of the left singular matrix U. For example, using notation that described in more detail below, the receiver processing matrix Q=(U(:,1:m))^{H} where m<n or, in other words, m≤M−1. The right singular matrices V can be used for beam forming to shape the transmissions so that transmissions from an AP to a non-associated STA includes nulling. The nulling may be partial or full. By way of illustration, the cross-BSS channel matrix H₁₂ can be used to determine a STA1-AP2 right singular matrix V₁₂, to create a null in a cross-BSS channel from AP2 to STA1.

### Independent SVD

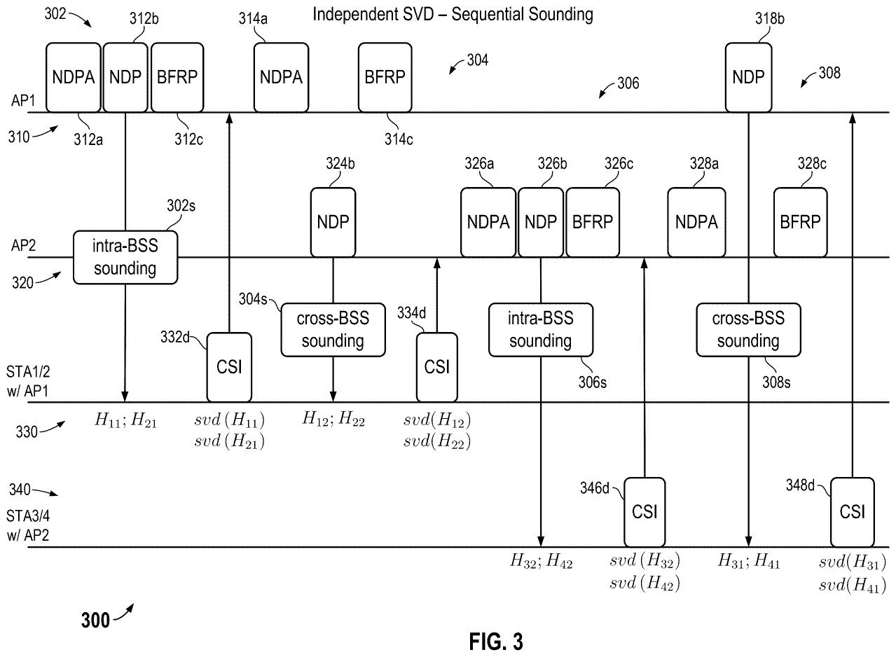

FIG. 3 is a sequence diagram 300 for sequential sounding using SVD.

Referring to FIG. 3, the sequence diagram 300 is for independent SVD with sequential sounding. The sequence diagram 300 is shown as including an AP1 sequence 310, an AP2 sequence 320, an AP1 associated STAs sequence 330, and an AP2 associated STAs sequence 340. The sequence diagram 300 is comprised of a first sequence 302, a second sequence 304, a third sequence 306, and a fourth sequence 308.

The first through fourth sequence 302-308 may begin with a null data packet announcement (NDPA) although any suitable initiating sequence step may be employed. The first through fourth sequence 302-308 may also include null data packets (NDP), channel state indicator (CSI) reports, a beam forming report poll (BFRP), and basic service set (BSS) soundings. The first through fourth sequence 302-308 can conclude with the AP1 or AP2 receiving a CSI report having sounding results including one or more CSI feedback matrices V, depending on the sequence.

The first sequence 302 may include a first sequence AP1 NDPA 312a and a first sequence AP1 NDP 312b transmitted by AP1. The first sequence 302 may also include a first sequence intra-BSS sounding 302s that may include the first sequence AP1 NDP 312b transmitted from AP1 to the AP1 associated STAs, such as the first and second STAs 220a, 220b described in the foregoing with reference to FIG. 2. The first sequence 302 can also include a first sequence AP1 BFRP 312c and a first sequence intra-BSS CSI report 332d that is transmitted in response to the first sequence AP1 BFRP 312c.

The second sequence 304 may include a second sequence AP1 NDPA 314a and a second sequence AP2 NDP 324b. The second sequence 304 can also include a second sequence cross-BSS sounding 304s that may include the second sequence AP2 NDP 324b. The second sequence 304 can also include a second sequence AP1 BFRP 314c and a second sequence AP2 cross-BSS CSI report 334d sent to AP2 in response to the second sequence AP1 BFRP 314c.

Referring still to FIG. 3, the third sequence 306 may include a third sequence AP2 NDPA 326a and a third sequence AP2 NDP 326b. The third sequence 306 may also include a third sequence intra-BSS sounding 306s that may include the third sequence AP2 NDP 326b. The third sequence 306 can also include a third sequence AP2 BFRP 326c and a third sequence AP2 intra-BSS CSI report 346d that may be sent to AP2 in response to the third sequence AP2 BFRP 326c.

The fourth sequence 308 may include a fourth sequence AP2 NDPA 328a and a fourth sequence AP1 NDP 318b. The fourth sequence 308 can also include a fourth sequence cross-BSS sounding 308s that includes the fourth sequence AP1 NDP 318b. The fourth sequence 308 can also include a fourth sequence AP2 BFRP 328c and a fourth sequence AP2 cross-BSS CSI report 348d sent to AP1 in response to the fourth sequence AP2 BFRP 328c.

Independent SVD can be performed for each relevant channel matrix Hᵢⱼ. The channel matrix Hᵢⱼ may be for one of the intra-BSS channels 232 or the cross-BSS channels 234. For example, an SVD performed on the STA1-AP1 intra-BSS channel matrix H₁₁ and the STA1-AP2 cross-BSS channel matrix H₁₂ can respectively be denoted as svd(H₁₁) and svd(H₁₂). For this example, the SVD can be represented as follows:

$$svd ( {H}_{11} ) = {U}_{11} {S}_{11} {V}_{11}^{H} ; and \qquad Equation [ 2 ]$$

$$svd ( {H}_{12} ) = {U}_{12} {S}_{12} {V}_{12}^{H} . \qquad Equation [ 3 ]$$

In independent SVD with sequential sounding, channel matrices H₁₁, H₂₁ may be determined based on the first sequence intra-BSS sounding 302s. The first sequence intra-BSS CSI report 332d may be based on the SVD of the channel matrices H₁₁, H₂₁, which is indicated by the svd(H₁₁) and svd(H₂₁). The first sequence intra-BSS CSI report 332d accordingly may include decomposition matrices, such as a STA1-AP1 right singular matrix V₁₁, a STA1-AP1 singular value matrix S₁₁, a STA2-AP1 right singular matrix V₂₁, and/or a STA2-AP1 singular value matrix S₂₁.

Similarly, the channel matrices H₁₂, H₂₂ may be determined based on the second sequence cross-BSS sounding 304s. An SVD may be performed on the channel matrices H₁₂, H₂₂ as is indicated by the svd(H₁₂) and svd(H₂₂). The second sequence AP2 cross-BSS CSI report 334d may feedback a normalized STA1-AP2 right singular matrix V₁₂, a STA1-AP2 singular value matrix S₁₂, a normalized STA2-AP2 right singular matrix V₂₂, and/or a STA2-AP2 singular value matrix S₂₂.

Also, in independent SVD with sequential sounding, channel matrices H₃₂, H₄₂ may be determined based on the third sequence intra-BSS sounding 306s. The third sequence AP2 intra-BSS CSI report 336d may be based on the SVD of the channel matrices H₃₂, H₄₂, which is indicated by the svd(H₃₂) and svd(H₄₂). The third sequence AP2 intra-BSS CSI report 336d accordingly may include decomposition matrices, such as a STA3-AP2 right singular matrix V₃₂, a STA3-AP2 singular value matrix S₃₂, a STA4-AP2 right singular matrix V₄₂, and/or a STA4-AP2 singular value matrix S₄₂.

Similarly, the channel matrices H₃₁, H₄₁ may be determined based on the fourth sequence cross-BSS sounding 308s. An SVD may be performed on the channel matrices H₃₁, H₄₁ as is indicated by the svd(H₃₁) and svd(H₄₁). The fourth sequence AP2 cross-BSS CSI report 338d may feedback a normalized STA3-AP1 singular value matrix V̅₃₁, a STA3-AP1 singular value matrix S₃₁, a normalized STA4-AP1 right singular matrix V̅₄₁, and a STA4-AP1 singular value matrix S₄₁.

Joint SVD with Joint Sounding in Co-BF

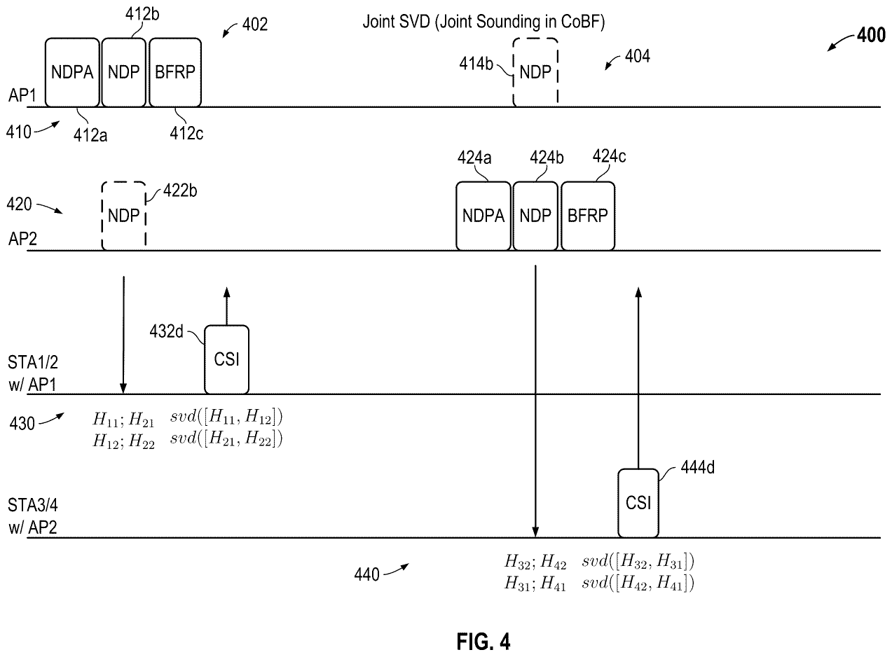

FIG. 4 is a sequence diagram 400 for joint SVD with joint sounding in Co-BFing.

Referring to FIG. 4, the sequence diagram 400 is for a separated SVD with joint sounding. The sequence diagram 400 is shown as including an AP1 sequence 410, an AP2 sequence 420, an AP1 associated STAs sequence 430, and an AP2 associated STAs sequence 440. The sequence diagram 400 may also include a first sequence 402 and a second sequence 404. The first and second sequence 402, 404 may begin with NDPAs transmitted by AP1 or AP2. The first and second sequence 402, 404 can also include NDPs and BFRPs transmitted from AP1 or AP2 to associated and/or non-associated STAs. The first and second sequence 402, 404 can further include CSI reports transmitted by STAs to APs in response to the BFRPs.

The first sequence 402 can include a first sequence AP1 NDPA 612a and a first sequence AP1 NDP 412b. The first sequence 402 may also include a first sequence AP2 NDP 422b transmitted by AP2. The first sequence AP1 and AP2 NDPs 412b, 422b may be transmitted to AP1 associated STAs, such as the first and second STAs 220a, 220b described in the foregoing with reference to FIG. 2. The first sequence 402 can also include a first sequence AP1 BFRP 412c and an AP1 associated STAs CSI report 432d that may be transmitted in response to the first sequence AP1 BFRP 412c.

Referring to FIG. 4, the second sequence 404 can include a second sequence AP2 NDPA 424a, a second sequence AP1 NDP 414a transmitted by AP1, and a second sequence AP2 NDP 424b transmitted by AP2. The second sequence AP1 NDP 414a and the second sequence AP2 NDP 424a may be received by the AP2 associated STAs, such as the third and fourth STAs 220c, 220d described above with reference to FIG. 2. The second sequence 404 can also include a second sequence AP2 BFRP and a second sequence AP2 associated STAs associated STAs 444d transmitted by the AP2 associated STAs.

Referring to the system 200 of FIG. 2, where the STA1 220a receives signals from the AP1 210a and the AP2 210b, joint SVD can be performed by evaluating svd([H₁₁, H₁₂]). With more particularity, a STA1 channel matrix H₁ can be defined as a concatenation of a STA1-AP1 channel matrix H₁₁ and a STA1-AP2 channel matrix H₁₂ as follows:

$${H}_{1} = [ {H}_{11} , {H}_{12} ] , \qquad Equation [ 4 ]$$

where the STA1-AP1 channel matrix H₁₁ and the STA1-AP2 channel matrix H₁₂ each have dimensions of 4×8, and the STA1 channel matrix H₁ may have dimensions of 4×16. SVD may be performed on the STA1 channel matrix H₁ as follows:

$$svd ( {H}_{1} ) = {U}_{1} {S}_{1} {V}_{1}^{H} = {U}_{1} {S}_{1} [ {V}_{J , 11}^{H} , {V}_{J , 12}^{H} ] ; \qquad Equation [ 5 ]$$

where the “J” subscript indicates a JSVD matrix. However, neither

$${V}_{J , 11}^{H}$$

nor

$${V}_{J , 12}^{H}$$

are unitary. The STA1 left singular matrix U_{J,1}, the STA1 singular value matrix S_{J,1}, and the STA1 right singular matrix

$${V}_{J , 1}^{H}$$

may respectively have dimensions of 4×4, 4×4, and 16×4.

In addition, in joint SVD, the STA1 CSI feedback matrix V₁, the singular value matrix S₁, and a normalized STA1 CSI feedback matrix V̅₁ can be feedbacked to the BFer which here is the AP1 210a. The normalized STA1 CSI feedback matrix V̅₁ may expressed or formatted as follows:

$${V}_{J , 1} = ( \begin{matrix}{V}_{J , 11} \\ {V}_{J , 12}\end{matrix} ) = ( \begin{matrix}{V}_{J , 11}^{( 1 )} & {V}_{J , 11}^{( 0 )} \\ {V}_{J , 12}^{( 1 )} & {V}_{J , 12}^{( 0 )}\end{matrix} ) ; \qquad Equation [ 6 ]$$

where the (1) and (0) superscripts respectively indicate matrices to be used and to not be used in beamforming. The expression or format shown in Equation [6] may be referred to as a joint sounding/JSVD feedback.

With respect to the superscripts (1) and (0), for the sake of discussion, we can assume that the STA1 left singular matrix U_{J,1}, the STA1 singular value matrix S_{J,1}, and STA1 right singular matrix V_{J,1} may respectively have dimensions of 4×4, 4×4, and 4×16. It should be appreciated that the specific dimensions of the decomposition matrices may depend on the configuration of a system, such as the system 200 described with reference to FIG. 2, as characterized by the decomposition matrices.

To illustrate the selection of portions of a matrix, the following notation can be employed using the foregoing dimensions of the STA1 left singular matrix U_{J,1}, the STA1 singular value matrix S_{J,1}, and STA1 right singular matrix V_{J,1} as an example:

$${U}_{J , 1} = ( {U}_{J , 1} ( : , 1 , 2 ) {U}_{J , 1} ( : , 3 : 4 ) ) = ( {U}_{J , 1}^{( 1 )} {U}_{J , 1}^{( 0 )} ) ; \qquad Equation [ 7 ]$$

$${S}_{J , 1} = ( \begin{matrix}{S}_{J , 1} ( 1 : 2 , 1 : 2 ) & {0}_{2 \times 2} \\ {0}_{2 \times 2} & {S}_{J , 1} ( 3 : 4 , 3 : 4 )\end{matrix} ) = ( \begin{matrix}{S}_{J , 1}^{( 0 )} & 0 \\ 0 & {S}_{J , 1}^{( 0 )}\end{matrix} ) ; \qquad Equation [ 8 ]$$

$$\begin{matrix}{V}_{J , 1} = ( \begin{matrix}{V}_{J , 1} ( 1 : 8 , 1 : 2 ) & {V}_{J , 1} ( 1 : 8 , 3 : 4 ) \\ {V}_{J , 1} ( 9 : 16 , 1 : 2 ) & {V}_{J , 1} ( 9 : 16 , 3 : 4 )\end{matrix} ) = ( \begin{matrix}{V}_{J , 11}^{( 1 )} & {V}_{J , 11}^{( 0 )} \\ {V}_{J , 12}^{( 1 )} & {V}_{J , 12}^{( 0 )}\end{matrix} ) \\ = ( {V}_{J , 1}^{( 1 )} {V}_{J , 1}^{( 0 )} ) = ( \begin{matrix}{V}_{J , 11} \\ {V}_{J , 12}\end{matrix} )\end{matrix} \qquad Equation [ 9 ]$$

The notation in the parenthesis of “r:r, c:c” employs indexes r and c to define a submatrix of a given decomposition matrix. The notation “r_{f}:rᵢ, c_{f}:cₗ” means a submatrix from a first indexed row r_{f} to a last indexed row rᵢ and a first indexed column c_{f} and a last indexed column cₗ of a matrix. Byway of illustration, a used joint STA1-AP1 right singular submatrix

$${V}_{J , 11}^{( 1 )}$$

can be defined as follows:

$${V}_{J , 11}^{( 1 )} = {V}_{J , 1} ( 1 : 8 , 1 : 2 ) ; \qquad Equation [ 12 ]$$

where rows 1 to 8 and columns 1 and 2 are selected from the joint STA1 right singular matrix V_{J,1}.

Referring to the STA1 right singular matrix V_{J,1}, rows 1 to 8 may be a joint STA1-AP1 right singular submatrix V_{J,1} and rows 9 through 16 might be a joint STA1-AP2 right singular submatrix V_{J,12}. In addition, columns 1 and 2 may be a used joint STA1 right singular submatrix

$${V}_{j , 1}^{( 1 )}$$

and columns 3 and 4 may be an unused joint STA1 right singular submatrix

$${V}_{J , 1}^{( 0 )} .$$

In a joint sounding JSVD/SSVD feedback a normalized joint STA1 right singular matrix V̅_{J,1} and a joint STA1 singular value matrix S_{1,1} may be sent by the STA1.
Separated SVD with Sequential Sounding

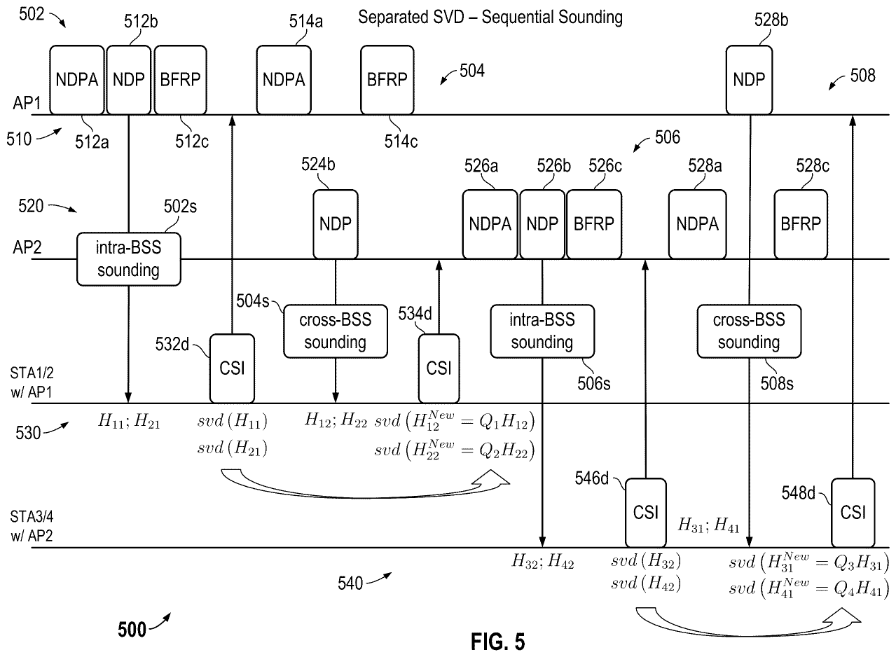

FIG. 5 is a sequence diagram 500 for separated SVD with sequential sounding.

Referring to FIG. 5, the sequence diagram 500 is for a separated SVD with sequential sounding. The sequence diagram 500 is shown as including an AP1 sequence 510, an AP2 sequence 520, an AP1 associated STAs sequence 530, and an AP2 associated STAs sequence 540. The sequence diagram 500 may also include a first sequence 502, a second sequence 504, a third sequence 506, and a fourth sequence 508. The first through fourth sequence 502-508 may begin with an NDPA although any suitable initiating sequence step may be employed. The first through fourth sequence 502-508 may also include NDPs, CSI reports, BFRPs, and BSS soundings. The first through fourth sequence 502-508 can conclude with the AP1 or AP2 receiving a CSI report having sounding feedback based on a right singular matrix H or a new right singular matrix H^{New}, depending on the sequence.

The first sequence 502 may include a first sequence AP1 NDPA 512a and a first sequence AP1 NDP 512b transmitted by AP1. The first sequence 502 may also include a first sequence AP1 cross-BSS sounding 502s that may include the first sequence AP1 NDP 512b transmitted from AP1 to the AP1 associated STAs, such as the STA1 and STA2 220a, 220b described above with reference to FIG. 2. The first sequence 502 can also include a first sequence AP1 BFRP 512c and a first sequence AP1 associated STAs CSI report 432d that is transmitted in response to the first sequence AP1 BFRP 512c.

The second sequence 504 may include a second sequence AP1 NDPA 514a and a second sequence AP2 NDP 524b. The second sequence 504 can also include a second sequence cross-BSS sounding 504s that may include the second sequence AP2 NDP 524b. The second sequence 504 can also include a second sequence AP1 BFRP 514c and a second sequence AP1 associated cross-BSS CSI report 534d sent to AP2 in response to the second sequence AP1 BFRP 514c.

Referring still to FIG. 5, the third sequence 506 may include a third sequence AP2 NDPA 526a and a third sequence AP2 NDP 526b. The third sequence 506 may also include a third sequence intra-BSS sounding 406s that may include the third sequence AP2 NDP 526b. The third sequence 406 can also include a third sequence AP2 BFRP 526c and a third sequence AP2 intra-BSS CSI report 446d that may be sent to AP2 in response to the third sequence AP2 BFRP 526c.

The fourth sequence 508 may include a fourth sequence AP2 NDPA 528a and a fourth sequence AP1 NDP 518b. The fourth sequence 408 can also include a fourth sequence cross-BSS sounding 508s that includes the fourth sequence AP1 NDP 518b. The fourth sequence 508 can also include a fourth sequence AP2 BFRP 528c and a fourth sequence AP2 cross-BSS CSI report 448d sent to AP1 in response to the fourth sequence AP2 BFRP 528c.

In general indexed notation, a SVD of a channel matrix Hᵢⱼ for an i-th STA and a j-th AP can be represented as:

$$svd ( {H}_{ij} ) = ( {U}_{ij}^{( 1 )} {U}_{ij}^{( 0 )} ) ( \begin{matrix}{S}_{ij}^{( 1 )} & 0 \\ 0 & {S}_{ij}^{( 0 )}\end{matrix} ) {( {V}_{ij}^{( 1 )} {V}_{ij}^{( 0 )} )}^{H} ; \qquad Equation [ 11 ]$$

where, for the system 200 described with reference to FIG. 2, ij={11, 21, 32, 42} for intra-BSS sounding. The cross-BSS separated SVD may be determined according to the following:

$$svd ( {H}_{ij}^{New} ) = {U}_{ij}^{New} {{S}_{ij}^{New} ( {V}_{ij}^{New} )}^{H} . \qquad Equation [ 12 ]$$

The superscripts of (1) and (0) may respectively indicate columns to be used and not used in beamforming and receiver processing. As will be explained in more detail in the following, STA processing matrices Qᵢ can be used with cross-BSS channel matrices to determine a new cross-BSS sounding results.

For example, with reference to FIG. 2, in separated SVD, SVD can be performed on intra-BSS channel matrices such as the STA1-AP1 channel matrix H₁₁ or the STA2-AP1 channel matrix H₂₁. The results of these SVDs can be feedbacked to the associated AP, which referring to FIG. 2, is the AP1 210a. In addition, the results of the SVD on the intra-BSS channel matrices can also be used to perform SVD on non-associated STA channel matrices, in contrast to the independent SVD described in the foregoing. In addition, in contrast to the joint SVD feedbacked CSI feedback matrix V₁₁, the feedbacked results from the separated SVD can be used for SU-MIMO.

By way of illustration, an SVD may be performed on the STA1-AP1 channel matrix H₁₁ as follows to determine a STA1-AP1 left singular matrix U₁₁ as follows:

$$svd ( {H}_{11} ) \to {U}_{11} . \qquad Equation [ 13 ]$$

A Hermitian transpose of the STA1-AP1 left singular matrix U₁₁ can be used to determine a STA1 processing matrix Q₁ as follows:

$${Q}_{1} = {( {U}_{11}^{( 1 )} )}^{H} . \qquad Equation [ 14 ]$$

Note that the superscript (1) may indicate columns that are to be used in receiver processing. The STA1 processing matrix Q₁ may strictly be based on (e.g., strictly comprise) a submatrix of the STA1-AP1 left singular matrix U₁₁. For example, with reference to the above described example of a joint STA1 channel matrix H₁ having dimensions of 4×16 and matrix indexing notation, the STA1 processing matrix Q₁ may comprise the first and second column of the STA1-AP1 left singular matrix

$${( {U}_{11}^{( 1 )} )}^{H} = {( ( {U}_{11} ( : , 1 : 2 ) ) )}^{H} .$$

Accordingly, the STA1 processing matrix Q₁ may have dimensions of 2×4, although any suitable submatrix dimensions may be employed.

The STA1 processing matrix Q₁ can then be used to perform SVD on an STA1-AP2 cross-BSS channel matrix H₁₂ as follows:

$$svd ( {H}_{12}^{New} = {Q}_{1} {H}_{12} ) = {U}_{12}^{New} {{S}_{12}^{New} ( {V}_{12}^{New} )}^{H} . \qquad Equation [ 15 ]$$

With reference to the STA1 channel matrix H₁ having dimensions of 2×16. The dimensions of the new STA1-AP2 channel matrix

$${H}_{12}^{New} = {Q}_{1} {H}_{12}$$

may be 2×8. The new STA1-AP2 decomposition matrices

$${U}_{12}^{New} , {S}_{12}^{New} , {V}_{12}^{New}$$

may respectively have dimensions of 2×2, 2×2, 2×8. The results of the SVD on the Q₁H₁₂ can be feedbacked. For example, the normal MU-MIMO results may be feedbacked: the intra-BSS and cross-BSS CSI feedback matrices comprising the STA1-AP1 and new STA1-right singular matrices V₁₁,

$${V}_{12}^{New} .$$

It should also be appreciated that normalized right singular matrices V̅₁₁,

$${\overline{V}}_{12}^{New}$$

may alternatively be feedbacked.

Referring to FIG. 5 for a more complete discussion, in separated SVD with sequential sounding, STA1 and STA2 channel matrices H₁₁, H₂₁ may be determined based on the first sequence intra-BSS sounding 502s. The first sequence AP1 associated STAs CSI report 432d may be based on the SVD of the STA1 and STA2 channel matrices H₁₁, H₂₁, which is indicated by the svd(H₁₁) and svd(H₂₁). The first sequence AP1 intra-BSS CSI report 532d accordingly may include decomposition matrices, such as a STA1-AP1 right singular matrix V₁₁, a STA1-AP1 singular value matrix S₁₁, a STA2-AP1 right singular matrix V₂₁, and/or a STA2-AP1 singular value matrix S₂₁.

The SVD of the STA1 and STA2 channel matrices H₁₁, H₂₁ can also determine a STA1-AP1 decomposition processing matrix U₁₁ in accordance with the above Equation [13]. In addition, the STA1 processing matrix Q₁ may also be determined according to the foregoing Equation [14]. The STA2 processing matrix Q₂ can similarly be determined as is indicated by the arrow from the svd(H₁₁) and the svd(H₂₁) to the STA1 and STA2 processing matrices Q₁, Q₂. The SVD of the STA1 and STA2 channel matrices H₁₁, H₂₁ can also provide the singular value matrices S, S₂₁, S₃₂, S₄₂ and the right singular matrices V₁₁, V₂₁, V₃₂, V₄₂.

SVD can be performed on a new STA1-AP2 channel matrix

$${H}_{12}^{New}$$

and a new STA2-AP2 channel matrix

$${H}_{22}^{New} .$$

For example, the new STA1-AP2 channel matrix

$${H}_{12}^{New}$$

can be defined as

$${H}_{12}^{New} = {Q}_{1} {H}_{12}$$

and the new STA2-AP2 channel matrix

$${H}_{22}^{New}$$

can be defined as

$${H}_{22}^{New} = {Q}_{2} {H}_{22} .$$

Accordingly, SVD may be performed as follows:

$$svd ( {H}_{12}^{New} = {Q}_{1} {H}_{12} )$$

and the

$$svd ( {H}_{22}^{New} = {Q}_{2} {H}_{22} )$$

according to the foregoing Equation [15] to determine new singular value matrices

$${S}_{12}^{New} , {S}_{22}^{New} , {S}_{31}^{New} , {S}_{41}^{New}$$

and new right singular matrices

$${V}_{12}^{New} , {V}_{22}^{New} , {V}_{31}^{New} , {V}_{41}^{New} .$$

The description of FIG. 5 pertains to performing a separated SVD using sequential sounding. The following describes an exemplary separated SVD using joint sounding.

Separated SVD with Joint Sounding

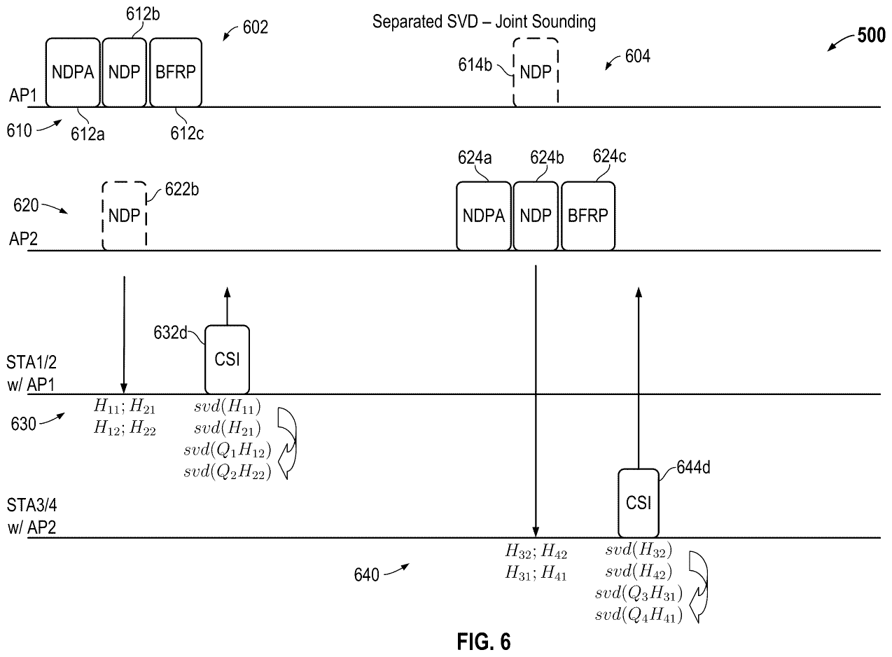

FIG. 6 is a sequence diagram 600 for separated SVD with joint sounding.

Referring to FIG. 6, the sequence diagram 600 is for a separated SVD with joint sounding. The sequence diagram 600 is shown as including an AP1 sequence 610, an AP2 sequence 620, an AP1 associated STAs sequence 630, and an AP2 associated STAs sequence 640. The sequence diagram 600 may also include a first sequence 602 and a second sequence 604. The first and second sequence 602, 604 may begin with NDPAs transmitted by AP1 or AP2. The first and second sequence 602, 604 can also include NDPs and BFRPs transmitted from AP1 or AP2 to associated and/or non-associated STAs. The first and second sequence 602, 604 can further include CSI reports transmitted by STAs to APs in response to the BFRPs.

The first sequence 602 can include a first sequence AP1 NDPA 612a and a first sequence AP1 NDP 612b. The first sequence 602 may also include a first sequence AP2 NDP 622b transmitted by AP2. The first sequence AP1 and AP2 NDPs 612b, 622b may be transmitted to AP1 associated STAs, such as the STA1 and STA2 220a, 220b described in the foregoing with reference to FIG. 2. The first sequence 602 can also include a first sequence AP1 BFRP 612c and an AP1 associated STAs CSI report 632d that may be transmitted in response to the first sequence AP1 BFRP 612c.

Referring to FIG. 6, the second sequence 604 can include a second sequence AP2 NDPA 624a, a second sequence AP1 NDP 614a transmitted by AP1, and a second sequence AP2 NDP 624b transmitted by AP2. The second sequence AP1 NDP 614a and the second sequence AP2 NDP 624a may be received by the AP2 associated STAs, such as the third and fourth STAs 220c, 220d described above with reference to FIG. 2. The second sequence 604 can also include a second sequence AP2 BFRP and a second sequence AP2 associated STAs CSI report 644d transmitted by an AP2 associated STA.

Referring to FIG. 6, the first sequence AP1 NDP 612b received by STA1 and/or STA2 can be used to determine a STA1-AP1 channel matrix H₁₁ and a STA2-AP1 channel matrix H₂₁. Similarly, the first sequence AP2 NDP 622b received by STA1 and/or STA2 can be used to determine an STA1-AP2 channel matrix H₁₂ and an STA2-AP2 channel matrix H₂₂. The first sequence AP1 NDP 612b and the first sequence AP2 NDP 522b can be received simultaneously. SVD can be performed on the STA1-AP1 channel matrix H₁₁ and the STA2-AP1 channel matrix H₂₁ to determine the right singular matrices V as described above with reference to Equations [2].

In the case of separated SVD feedback from joint sounding, an existing joint SVD can be reused. For example, referring to FIG. 2, the STA1 220a feedback may be:

$$\{ {S}_{11}^{( 1 )} , {V}_{11}^{( 1 )} , {V}_{11}^{New} \} . \qquad Equation [ 16 ]$$

Note that a full dimension intra-BSS sounding feedback may include {S₁₁, V₁₁}, {S₂₁, V₂₁}, {S₃₂, V₃₂}, and {S₄₂, V₄₂}, which may be sufficient for reuse in MU-MIMO and SU-MIMO.

Accordingly, a full dimension feedback, including intra-BSS sounding and cross-BSS sounding, for all of the stations may be as summarized in the following table:

TABLE
Feedbacks of STAs

| Station | Feedback |
|---|---|
| STA1 | $\{ {S}_{11} , ( \frac{1}{\sqrt{2}} [ \begin{matrix}{V}_{11}^{( 1 )} \\ {V}_{12}^{New}\end{matrix} ] , [ \begin{matrix}{V}_{11}^{( 0 )} \\ 0\end{matrix} ] ) \} \qquad Eq . [ 17 ]$ |
| STA2 | $\{ {S}_{21} , ( \frac{1}{\sqrt{2}} [ \begin{matrix}{V}_{21}^{( 1 )} \\ {V}_{22}^{New}\end{matrix} ] , [ \begin{matrix}{V}_{21}^{( 0 )} \\ 0\end{matrix} ] ) \} \qquad Eq . [ 18 ]$ |
| STA3 | $\{ {S}_{31} , ( \frac{1}{\sqrt{2}} [ \begin{matrix}{V}_{32}^{( 1 )} \\ {V}_{31}^{New}\end{matrix} ] , [ \begin{matrix}{V}_{32}^{( 0 )} \\ 0\end{matrix} ] ) \} \qquad Eq . [ 19 ]$ |
| STA4 | $\{ {S}_{41} , ( \frac{1}{\sqrt{2}} [ \begin{matrix}{V}_{42}^{( 1 )} \\ {V}_{41}^{New}\end{matrix} ] , [ \begin{matrix}{V}_{42}^{( 0 )} \\ 0\end{matrix} ] ) \} \qquad Eq . [ 20 ]$ |

The joint sounding from JSVD feedback formats shown in Table 1 are exemplary. Other feedback formats may be employed.

With respect to whether the feedback can be used for MU-MIMO and SU-MIMO, the STA1 CSI feedback matrix:

$${V}_{1} = ( \begin{matrix}{V}_{J , 11}^{( 1 )} & {V}_{J , 11}^{( 0 )} \\ {V}_{J , 12}^{( 1 )} & {V}_{J , 12}^{( 0 )}\end{matrix} ) = ( \frac{1}{\sqrt{2}} [ \begin{matrix}{V}_{11}^{( 1 )} \\ {V}_{12}^{New}\end{matrix} ] , [ \begin{matrix}{V}_{11}^{( 0 )} \\ 0\end{matrix} ] ) = ( \begin{matrix}{V}_{11}^{( 1 )} / \sqrt{2} & {V}_{11}^{( 0 )} \\ {V}_{12}^{New} / \sqrt{2} & 0\end{matrix} ) , \qquad Equation [ 21 ]$$

meets the definition of a unitary matrix:

$${V}_{1}^{H} {V}_{1} = I .$$

As can be appreciated form comparison of the left-hand side and the right-hand side of Equation [21], the following relationships can be derived:

$${V}_{J , 11}^{( 1 )} = \frac{1}{\sqrt{2}} {V}_{11}^{( 1 )} , {V}_{J , 12}^{( 1 )} = \frac{1}{\sqrt{2}} {V}_{12}^{N e w} , {V}_{J , 11}^{( 0 )} = {V}_{11}^{( 0 )} , and {V}_{J , 12}^{( 0 )} = 0 .$$

In general, for Equation [21], V̅_{J,1}≠V_{J,1}. The format or expression shown in Equation [21] may be referred to as a joint sounding/SSVD feedback form.

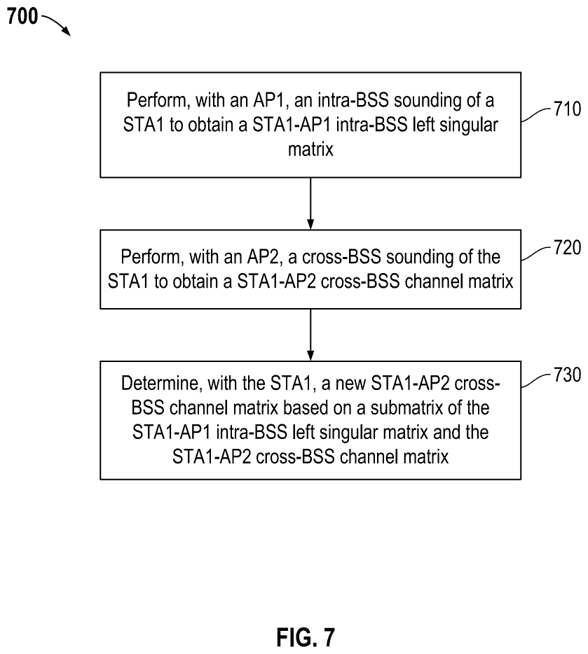

FIG. 7 is a method 700 for Co-BFing using separated SVD.

Referring to FIG. 7, the method 700 may perform, with an AP1, an intra-BSS sounding of a STA1 to obtain an STA1-AP1 intra-BSS left singular matrix U₁₁ in step 710. In step 720, the method 700 can perform, with an AP2, a cross-BSS sounding of the STA1 to obtain a STA1-AP2 cross-BSS channel matrix H₁₂. The method 700, in step 730, can determine, with the STA1, a new STA1-AP2 cross-BSS channel matrix

$${H}_{12}^{New}$$

based on a submatrix of the STA1-AP1 intra-BSS left singular matrix U₁₁ and the STA1-AP2 cross-BSS channel matrix H₁₂.

Performing, with the AP1, the intra-BSS sounding of a STA1 to obtain an STA1-AP1 intra-BSS left singular matrix U₁₁ may comprise transmitting, with the AP1, a null data packet (NDP) from the AP1 to the STA1, determining, with the STA1, a STA1-AP1 channel matrix H₁₁ based on the NDP received by the STA1, and performing, with the STA1, a singular value decomposition (SVD) on the STA1-AP1 channel matrix H₁₁ to obtain the STA1-AP1 intra-BSS left singular matrix U₁₁. Performing, with the AP2, the cross-BSS sounding of the STA1 to obtain the STA1-AP2 cross-BSS channel matrix H₁₂ comprises transmitting, with the AP2, an AP2 NDP to the STA1 and determining the STA1-AP2 cross-BSS channel matrix H₁₂ based on the AP2 NDP.

Additionally, or alternatively, determining, with the STA1, the new STA1-AP2 cross-BSS channel matrix

$${H}_{12}^{New}$$

based on the submatrix of the STA1-AP1 intra-BSS left singular matrix U₁₁ and the STA1-AP2 cross-BSS channel matrix H₁₂ may comprise determining, with the STA1, an STA1 receiver processing matrix Q₁ based on the submatrix of the STA1-AP1 intra-BSS left singular matrix U₁₁ and determining, with the STA1, the new STA1-AP2 cross-BSS channel matrix

$${H}_{12}^{New}$$

based on the STA1 receiver processing matrix Q₁ and the STA1-AP2 cross-BSS channel matrix H₁₂.

Determining, with the STA1, the STA1 receiver processing matrix Q₁ based on the submatrix of the STA1-AP1 intra-BSS left singular matrix U₁₁ comprises determining, with the STA1, the STA1 receiver processing matrix Q₁ based on a Hermitian transpose of a submatrix of the STA1-AP1 intra-BSS left singular matrix U₁₁. Determining, with the STA1, the new STA1-AP2 cross-BSS channel matrix

$${H}_{12}^{N e w}$$

based on the STA1 receiver processing matrix Q₁ and the STA1-AP2 cross-BSS channel matrix H₁₂ comprises multiplying, with the STA1, the STA1 receiver processing matrix Q₁ with the STA1-AP2 cross-BSS channel matrix H₁₂.

Additionally, or alternatively, the method 700 may further determine, with the STA1, a new STA1-AP2 cross-BSS right singular matrix

$${V}_{12}^{N e w}$$

based on the new STA1-AP2 cross-BSS channel matrix

$${H}_{12}^{N e w} .$$

Determining, with the STA1, the new STA1-AP2 right singular matrix

$${V}_{12}^{New}$$

based on the new STA1-AP2 cross-BSS channel matrix

$${H}_{12}^{New}$$

may comprise performing, with the STA1, an SVD on the new STA1-AP2 cross-BSS channel matrix

$${H}_{12}^{New}$$

to obtain the new STA1-AP2 right singular matrix

$${V}_{12}^{New} .$$

The method 700 can further comprise sending, with the STA1, the new STA1-AP2 cross-BSS right singular matrix

$${V}_{12}^{New}$$

to the AP2. Sending, with the STA1, the new STA1-AP2 cross-BSS right singular matrix

$${V}_{12}^{New}$$

to the AP2 may comprise sending to the AP2, with the STA1, the new STA1-AP2 cross-BSS right singular matrix

$${V}_{12}^{New}$$

concatenated with a STA1-AP1 intra-BSS right singular matrix V₁₁ determined based on the intra-BSS sounding of the STA1. The method 700 can further comprise sending, with the STA1, the new STA1-AP2 cross-BSS right singular matrix

$${V}_{12}^{New}$$

concatenated with a STA1-AP1 intra-BSS left singular matrix V₁₁ determined based on the intra-BSS sounding of the STA1 to the AP1.

Additionally, or alternatively, the method 700 can further comprise at least one of determining, with a second station (STA2), a new STA2-AP2 cross-BSS channel matrix

$${H}_{22}^{New}$$

based on an STA2-AP1 intra-BSS left singular matrix U₂₁ and an STA2-AP2 cross-BSS channel matrix H₂₂ and determining, with a third station (STA3), a new STA3-AP1 cross-BSS channel matrix

$${H}_{31}^{New}$$

based on an STA3-AP2 intra-BSS left singular matrix U₃₂ and an STA3-AP1 cross-BSS channel matrix H₃₁.

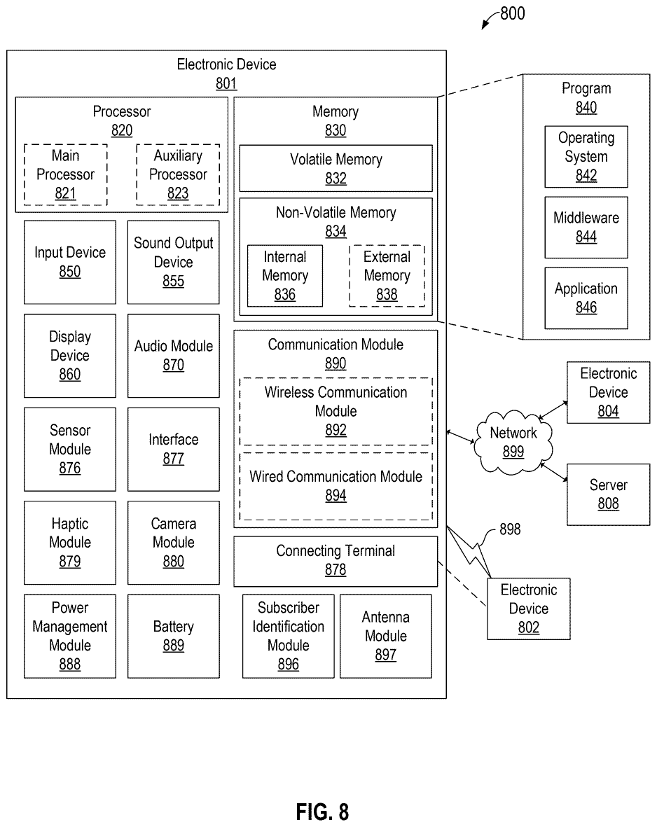

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations, such as those related to the Co-BFing with separated singular value decomposition. For example, the processor 820 may determine an STA1-AP1 intra-BSS left singular matrix U₁₁ based on the intra-BSS sounding from the AP1, determine a STA1-AP2 cross-BSS channel matrix H₁₂ based on the cross-BSS sounding from the AP2, and determine a new STA1-AP2 cross-BSS channel matrix

$${H}_{12}^{New}$$

based on a submatrix of the STA1-AP1 intra-BSS left singular matrix U₁₁ and the STA1-AP2 cross-BSS channel matrix H₁₂. The processor 820 may perform additional or alternative steps related to Co-BFing with separated SVD.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor) and supports a direct (e.g., wired) communication or a wireless communication.

The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

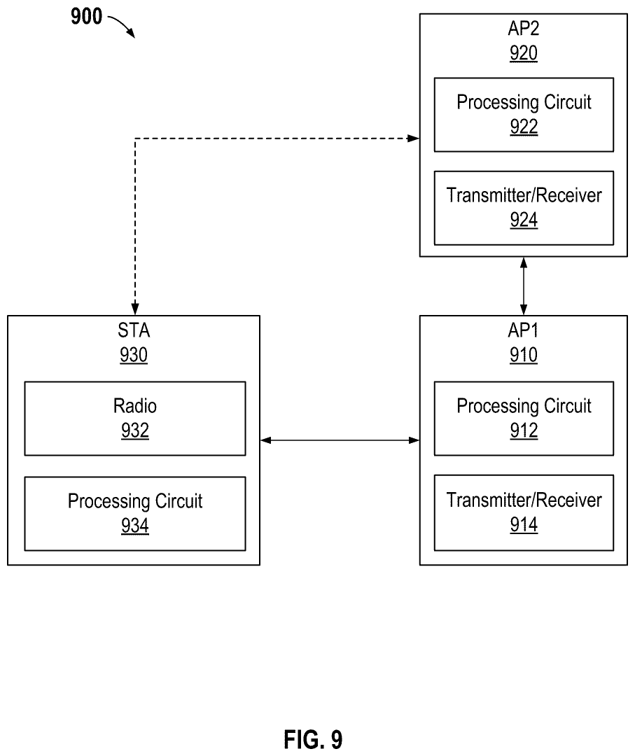

FIG. 9 shows a system 900 including an AP1 910, an AP2 920, and a STA 930.

Referring to FIG. 9, the AP1 910 is communicatively coupled with the STA 930 illustrated by a solid line. The AP1 910 may be communicatively coupled with the STA 930 via wireless uplinks and/or downlinks. The AP1 910 and the AP2 920 are also communicatively coupled with each other as is also illustrated by a solid line. The AP1 910 and the AP2 920 may be communicatively coupled with each other through backhaul connections, fronthaul wireless communications, and/or etc. The AP2 920 and the STA 930 are not shown as being communicatively coupled but instead include some transmissions, direct or indirect between the AP2 920 and the STA 930 as is illustrated by the dashed arrow line.

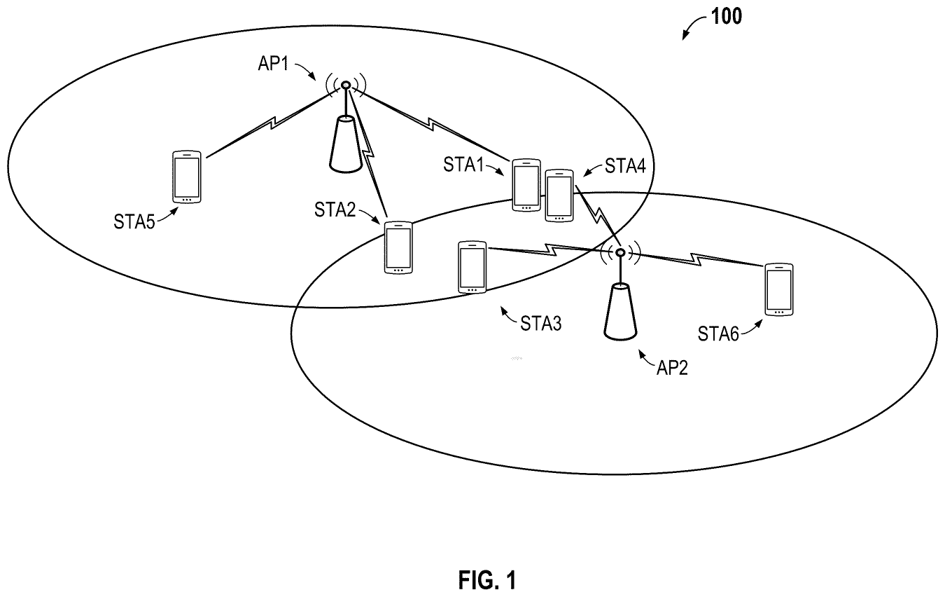

With reference to FIGS. 1 and 9, the AP1 910 and the STA 930 may be considered associated with each other and thus be part of a BSS. For example, the STA 930 may be the STA2 shown in FIG. 1. Accordingly, the BSS that includes the AP1 910 and the STA 930 shown in FIG. 9 may overlap with another BSS that includes the AP2 920 and thus may be an OBSS. The AP2 920 may therefore, for example, overhear communications between the AP1 910 and the STA 930 even though the AP2 920 may not be communicatively coupled with (e.g., associated with) the STA 930.

The AP1 910 and the AP2 920 may be any suitable combination of hardware and/or software that can provide wireless services to the STA 930. For example, the AP1 910 and the AP2 920 may respectively be comprised of a processing circuit 912, 922 and a transmitter/receiver 914, 924. The processing circuits 912, 922 may be any suitable combination of circuits, registers, code, and/or the like that can perform computations, such as, for example, those described herein. Additionally or alternatively, the AP1 910 and the AP2 920 may be comprised of antennas (e.g., in one or more antenna arrays) for communications with, for example, the STA 930 and/or each other, a wired network interface to a router or switch, and/or the like. It should be appreciated that the term “access point” may be interchangeable with other terms such as “base station”, Next-Generation Node B (gNB), etc.

The STA 930 may include a radio 932 and a processing circuit 934. The radio 932 which may perform various methods disclosed herein. For example, the processing circuit 934 may receive, via the radio 932, transmissions from the AP1 910, and the processing circuit 920 may transmit, via the radio 932, signals to the AP1 910. Accordingly, the AP1 910 can transmit, for example, packets with or without data (e.g., symbols) via a transmission (e.g., across specific spatial stream) from the AP1 910 to the STA 930.

The processing circuit 934 can perform steps related to Co-BFing with separated SVD. For example, the processing circuit 934 can determine an STA1-AP1 intra-BSS left singular matrix U₁₁ based on the intra-BSS sounding from the AP1, determine a STA1-AP2 cross-BSS channel matrix H₁₂ based on the cross-BSS sounding from the AP2, and determine a new STA1-AP2 cross-BSS channel matrix

$${H}_{12}^{New}$$

based on a submatrix of the STA1-AP1 intra-BSS left singular matrix U₁₁ and the STA1-AP2 cross-BSS channel matrix H₁₂. The processing circuit 834 can perform additional or alternative steps.

It should also be appreciated that the AP2 920 can also transmit to the STA 930 even though the AP2 920 and the STA 930 may not be associated. For example, the AP1 910 and/or the AP2 920 may transmit an NDPA to coordinate sequential and/or simultaneous transmissions from AP1 910 and/or AP2 920 to the STA 930 as is described in the foregoing. By way of illustration, based on the NDPA, the AP1 910 and/or the AP2 920 can transmit an NDP, simultaneously, sequentially, or individually, to the STA 930.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
performing, with a first access point (AP1), an intra-basic service set (BSS) sounding of a first station (STA1) to obtain an STA1-AP1 intra-BSS left singular matrix U₁₁;
performing, with a second access point (AP2), a cross-BSS sounding of the STA1 to obtain a STA1-AP2 cross-BSS channel matrix H₁₂; and
determining, with the STA1, a new STA1-AP2 cross-BSS channel matrix
$${H}_{12}^{New}$$
based on a submatrix of the STA1-AP1 intra-BSS left singular matrix U₁₁ and the STA1-AP2 cross-BSS channel matrix H₁₂.

2. The method of claim 1, wherein performing, with the AP1, the intra-BSS sounding of a first station (STA1) to obtain an STA1-AP1 intra-BSS left singular matrix U₁₁ comprises:
transmitting, with the AP1, a null data packet (NDP) from the AP1 to the STA1;
determining, with the STA1, a STA1-AP1 channel matrix H₁₁ based on the NDP received by the STA1; and
performing, with the STA1, a singular value decomposition (SVD) on the STA1-AP1 channel matrix H₁₁ to obtain the STA1-AP1 intra-BSS left singular matrix U₁₁.

3. The method of claim 1, wherein performing, with the AP2, the cross-BSS sounding of the STA1 to obtain the STA1-AP2 cross-BSS channel matrix H₁₂ comprises transmitting, with the AP2, an AP2 NDP to the STA1 and determining the STA1-AP2 cross-BSS channel matrix H₁₂ based on the AP2 NDP.

4. The method of claim 1, wherein determining, with the STA1, the new STA1-AP2 cross-BSS channel matrix
$${H}_{12}^{New}$$
based on the submatrix of the STA1-AP1 intra-BSS left singular matrix U₁₁ and the STA1-AP2 cross-BSS channel matrix H₁₂ comprises:
determining, with the STA1, an STA1 receiver processing matrix Q₁ based on the submatrix of the STA1-AP1 intra-BSS left singular matrix U₁₁; and
determining, with the STA1, the new STA1-AP2 cross-BSS channel matrix
$${H}_{12}^{New}$$
based on the STA1 receiver processing matrix Q₁ and the STA1-AP2 cross-BSS channel matrix H₁₂.

5. The method of claim 4, wherein determining, with the STA1, the STA1 receiver processing matrix Q₁ based on the submatrix of the STA1-AP1 intra-BSS left singular matrix U₁₁ comprises determining, with the STA1, the STA1 receiver processing matrix Q₁ based on a Hermitian transpose of a submatrix of the STA1-AP1 intra-BSS left singular matrix U₁₁.

6. The method of claim 4, wherein determining, with the STA1, the new STA1-AP2 cross-BSS channel matrix
$${H}_{12}^{New}$$
based on the STA1 receiver processing matrix Q₁ and the STA1-AP2 cross-BSS channel matrix H₁₂ comprises multiplying, with the STA1, the STA1 receiver processing matrix Q₁ with the STA1-AP2 cross-BSS channel matrix H₁₂.

7. The method of claim 1, further comprising determining, with the STA1, a new STA1-AP2 cross-BSS right singular matrix
$${V}_{12}^{New}$$
based on the new STA1-AP2 cross-BSS channel matrix
$${H}_{12}^{N e w} .$$

8. The method of claim 7, wherein determining, with the STA1, the new STA1-AP2 right singular matrix
$${V}_{12}^{N e w}$$
based on the new STA1-AP2 cross-BSS channel matrix
$${H}_{12}^{N e w}$$
comprises performing, with the STA1, an SVD on the new STA1-AP2 cross-BSS channel matrix
$${H}_{12}^{N e w}$$
to obtain the new STA1-AP2 right singular matrix
$${V}_{12}^{N e w} .$$

9. The method of claim 7, further comprising sending, with the STA1, the new STA1-AP2 cross-BSS right singular matrix
$${V}_{12}^{N e w}$$
to the AP2.

10. The method of claim 9, wherein sending, with the STA1, the new STA1-AP2 cross-BSS right singular matrix
$${V}_{12}^{N e w}$$
to the AP2 comprises sending to the AP2, with the STA1, the new STA1-AP2 cross-BSS right singular matrix
$${V}_{12}^{N e w}$$
concatenated with a STA1-AP1 intra-BSS right singular matrix V₁₁ determined based on the intra-BSS sounding of the STA1.

11. The method of claim 10, further comprising sending, with the STA1, the new STA1-AP2 cross-BSS right singular matrix
$${V}_{12}^{N e w}$$
concatenated with a STA1-AP1 intra-BSS left singular matrix V₁₁ determined based on the intra-BSS sounding of the STA1 to the AP1.

12. The method of claim 1, further comprising at least one of:
determining, with a second station (STA2), a new STA2-AP2 cross-BSS channel matrix
$${H}_{22}^{N e w}$$
based on an STA2-AP1 intra-BSS left singular matrix U₂₁ and an STA2-AP2 cross-BSS channel matrix H₂₂; and
determining, with a third station (STA3), a new STA3-AP1 cross-BSS channel matrix
$${H}_{31}^{N e w}$$
based on an STA3-AP2 intra-BSS left singular matrix U₃₂ and an STA3-AP1 cross-BSS channel matrix H₃₁.

13. A system comprising:
a first access point (AP1) configured to perform an intra-basic service set (BSS) sounding of a first station (STA1) to obtain an STA1-AP1 intra-BSS left singular matrix U₁₁;
a second access point (AP2) configured to perform a cross-BSS sounding of the STA1 to obtain a STA1-AP2 cross-BSS channel matrix H₁₂; and
the STA1 configured to determine a new STA1-AP2 cross-BSS channel matrix
$${H}_{12}^{N e w}$$
based on a submatrix of the STA1-AP1 intra-BSS left singular matrix U₁₁ and the STA1-AP2 cross-BSS channel matrix H₁₂.

14. The system of claim 13, wherein the AP1 being configured to perform the intra-BSS sounding of a first station (STA1) to obtain an STA1-AP1 intra-BSS left singular matrix U₁₁ comprises:
the AP1 being configured to transmit a null data packet (NDP) from the AP1 to the STA1;
the STA1 being configured to:
determine a STA1-AP1 channel matrix H₁₁ based on the NDP received by the STA1; and
perform a singular value decomposition (SVD) on the STA1-AP1 channel matrix H₁₁ to obtain the STA1-AP1 intra-BSS left singular matrix U₁₁.

15. The system of claim 13, wherein the AP2 being configured to perform the cross-BSS sounding of the STA1 to obtain the STA1-AP2 cross-BSS channel matrix H₁₂ comprises the AP2 being configured to transmit an AP2 NDP to the STA1 and determining the STA1-AP2 cross-BSS channel matrix H₁₂ based on the AP2 NDP.

16. The system of claim 13, wherein STA1 being configured to determine the new STA1-AP2 cross-BSS channel matrix
$${H}_{12}^{N e w}$$
based on the STA1-AP1 intra-BSS left singular matrix U₁₁ and the STA1-AP2 cross-BSS channel matrix H₁₂ comprises:
the STA1 being configured to determine an STA1 receiver processing matrix Q₁ based on the STA1-AP1 intra-BSS left singular matrix U₁₁; and
the STA1 being configured to determine the new STA1-AP2 cross-BSS channel matrix
$${H}_{12}^{N e w}$$
based on the STA1 receiver processing matrix Q₁ and the STA1-AP2 cross-BSS channel matrix H₁₂.

17. The system of claim 16, wherein the STA1 being configured to determine the STA1 receiver processing matrix Q₁ based on the submatrix of the STA1-AP1 intra-BSS left singular matrix U₁₁ comprises the STA1 being configured to determine the STA1 receiver processing matrix Q₁ based on a Hermitian transpose of the submatrix of the STA1-AP1 intra-BSS left singular matrix U₁₁.

18. The system of claim 16, wherein the STA1 being configured to determine the new STA1-AP2 cross-BSS channel matrix
$${H}_{12}^{N e w}$$
based on the STA1 receiver processing matrix Q₁ and the STA1-AP2 cross-BSS channel matrix H₁₂ comprises the STA1 being configured to multiply the STA1 receiver processing matrix Q₁ with the STA1-AP2 cross-BSS channel matrix H₁₂.

19. The system of claim 13, wherein the STA1 is further configured to determine a new STA1-AP2 cross-BSS right singular matrix
$${V}_{12}^{New}$$
based on the new STA1-AP2 cross-BSS channel matrix
$${H}_{12}^{New} .$$

20. The system of claim 19, wherein the STA1 being configured to determine the new STA1-AP2 right singular matrix
$${V}_{12}^{New}$$
based on the new STA1-AP2 cross-BSS channel matrix
$${H}_{12}^{New}$$
comprises the STA1 being configured to perform an SVD on the new STA1-AP2 cross-BSS channel matrix
$${H}_{12}^{New}$$
to obtain the new STA1-AP2 right singular matrix
$${V}_{12}^{New} .$$

21. The system of claim 19, wherein the STA1 is further configured to send the new STA1-AP2 cross-BSS right singular matrix
$${V}_{12}^{New}$$
to the AP2.

22. The system of claim 21, wherein the STA1 being configured to send the new STA1-AP2 cross-BSS right singular matrix
$${V}_{12}^{New}$$
to the AP2 comprises the STA1 being configured to send to the AP2 the new STA1-AP2 cross-BSS right singular matrix
$${V}_{12}^{New}$$
concatenated with a STA1-AP1 intra-BSS right singular matrix V₁₁ determined based on the intra-BSS sounding of the STA1.

23. The system of claim 22, wherein the STA1 is further configured to send the new STA1-AP2 cross-BSS right singular matrix
$${V}_{12}^{New}$$
concatenated with a STA1-AP1 intra-BSS right singular matrix V₁₁ determined based on the intra-BSS sounding of the STA1 to the AP1.

24. The system of claim 13, further comprising at least one of:
a second station (STA2) configured to determine a new STA2-AP2 cross-BSS channel matrix
$${H}_{22}^{New}$$
based on an STA2-AP1 intra-BSS left singular matrix U₂₁ and an STA2-AP2 cross-BSS channel matrix H₂₂; and
a third station (STA3) configured to determining a new STA3-AP1 cross-BSS channel matrix
$${H}_{31}^{New}$$
based on an STA3-AP2 intra-BSS left singular matrix U₃₂ and an STA3-AP1 cross-BSS channel matrix H₃₁.

25. A station (STA1) comprising:
a radio configured to receive an intra-basic service set (BSS) sounding from first access point (AP1) and receive a cross-BSS sounding from a second access point (AP2); and
a processing circuit configured to:
determine an STA1-AP1 intra-BSS left singular matrix U₁₁ based on the intra-BSS sounding from the AP1;
determine a STA1-AP2 cross-BSS channel matrix H₁₂ based on the cross-BSS sounding from the AP2; and
determine a new STA1-AP2 cross-BSS channel matrix
$${H}_{12}^{New}$$
based on a submatrix of the STA1-AP1 intra-BSS left singular matrix U₁₁ and the STA1-AP2 cross-BSS channel matrix H₁₂.

26. The STA of claim 25, wherein the processing circuit being configured to determine the new STA1-AP2 cross-BSS channel matrix
$${H}_{12}^{New}$$
based on the STA1-AP1 intra-BSS left singular matrix U₁₁ and the STA1-AP2 cross-BSS channel matrix H₁₂ comprises:
the processing circuit being configured to determine an STA1 receiver processing matrix Q₁ based on the STA1-AP1 intra-BSS left singular matrix U₁₁; and
the processing circuit being configured to determine the new STA1-AP2 cross-BSS channel matrix
$${H}_{12}^{New}$$
based on the STA1 receiver processing matrix Q₁ and the STA1-AP2 cross-BSS channel matrix H₁₂.
